(19) United States
(12) Patent Application Publication
(10) Pub. No.: US 2026/0208762 A1
(43) Pub. Date: Jul. 23, 2026

(54) Generating a Trajectory for an Autonomous Vehicle

(71) Applicant: Oxa Autonomy Ltd, Oxford (GB)

(72) Inventors: Andrew English, Oxford (GB); Norina Ratiu, Oxford (GB); Chi Tong, Oxford (GB); Ben Upcroft, Oxford (GB)

(73) Assignee: Oxa Autonomy Ltd, Oxford (GB)

(21) Appl. No.: 19/142,202

(22) PCT Filed: Dec. 14, 2023
(86) PCT No.: PCT/GB2023/053242

§ 371 Date: Jun. 21, 2025

(30) Foreign Application Priority Data
Dec. 21, 2022 (GB) 2219342.9

(51) Int. Cl. B60W 60/00; B60W 30/09; B60W 30/095; G01S 7/41; G01S 13/86; G01S 13/931

(52) U.S. Cl. CPC B60W 60/0011; B60W 30/09; B60W 30/0956; B60W 60/0015; G01S 7/417; G01S 13/865; G01S 13/931; B60W 2420/408; B60W 2556/20

(57) ABSTRACT

Systems and methods for generating a trajectory for an autonomous vehicle, AV, using an autonomy stack are disclosed. The autonomy stack can include a first component for generating a AV trajectory based on sensor inputs and a second component for adjusting the trajectory based on the sensor inputs. Both the first and second components can each include a perception module and a planning module. The method can include: identifying, using a perception module of a first component, objects based on sensor inputs; generating, using a planning module of the first component, a trajectory for the AV based on the objects identified by the perception module of the first component; identifying, using a perception module of a second component, objects based on the sensor inputs; and adjusting, using a planning module of the second component, the trajectory based on the objects identified by the perception module of the second component.

### FIELD

The subject-matter of the present disclosure relates to trajectory generation and control of autonomous vehicles. More specifically, the subject-matter relates to computer-implemented methods of generating a trajectory for an autonomous vehicle, training a machine learning model to identify objects used in generating the trajectory.

### BACKGROUND

Typical autonomy stacks include various components, or modules, that are rules based. It is difficult and time consuming to extend such autonomy stacks to new operating domains as the resulting rules-based modules will be extremely complex. It is possible to extend the functionality of autonomy stacks to new domains more easily using data based, or learned, models in the autonomy stack. However, there are drawbacks of constructing an autonomy stack entirely from learned models. For example, the black box nature of learned models means failure modes may be difficult to diagnose, and the outputs for the learned models may be difficult to predict and sometimes may be unreliable.

It is an aim of the present invention to address such problems and improve on the prior art.

### SUMMARY

According to an aspect of the present disclosure, there is provided a computer-implemented method of generating a trajectory for an autonomous vehicle, AV, using an autonomy stack. The autonomy stack includes a first component and a second component, the first component for generating a trajectory for the AV based on sensor inputs and the second component for adjusting the trajectory based on the sensor inputs, the first and second components each including a perception module and a planning module. The computer-implemented method comprising: identifying, using the perception module of the first component, objects based on sensor inputs; generating, using the planning module of the first component, a trajectory for the AV based on the objects identified by the perception module of the first component; identifying, using a perception module of the second component, objects based on the sensor inputs; and adjusting, using the planning module of the second component, the trajectory based on the objects identified by the perception module of the second component, wherein the perception module of the second component includes one or more rules-based models and one or more machine learning models.

Using a hybrid architecture including machine learning models and rules-based models to identify the objects used when adjusting the trajectory means that the architecture is more flexible than a solely rules-based architecture and is more predictable and fault detection is easier than with an architecture including solely rules-based models. The adjusting the trajectory based on the objects may include adjusting the trajectory to avoid the objects.

In an embodiment, the identifying, using the perception module of the first component, objects based on sensor inputs may comprise identifying, by the perception module of the first component, the objects and labelling, by the perception module of the first component, the objects semantically, and wherein, the identifying, using the perception module of the second component, objects based on the sensor inputs may comprise identifying, using the perception module of the second component, the objects and labelling, by the perception module of the second component, each of the identified objects as generic objects.

Labelling the objects from the perception module of the second component as generic means that any predictions based on them by downstream modules of the architecture will be performed in a shorter time period and have reduced processing requirements.

In an embodiment, the one or more machine learning models trained to identify objects from sensor inputs may comprise a first machine learning model trained to identify objects based on input images.

In an embodiment, the one or more machine learning models trained to identify objects from sensor inputs may comprise a second machine learning model trained to identify objects based on radar point cloud data and/or LiDAR point cloud data. It is easy to combine RADAR and LiDAR data into a single point cloud.

If a single machine learning model is used to identify objects from a single hybrid point cloud, the method may be able to process data more efficiently.

In an embodiment, the identifying, using the perception module of the second component, objects based on the sensor inputs may comprise: generating, using the first machine learning model, a first occupancy grid; and generating, using the second machine learning model, a second occupancy grid, wherein, the identifying, using the one of more rules-based models, a third occupancy grid, wherein the first, second, and third occupancy grids each comprise a plurality of grid segments, each segment of the plurality of grid segments labelled with a state selected from a list of states including occupied and object velocity, free-space, and occluded.

Using these states ensures that processing is quick and efficient in comparison to using a more detailed and complex list of states.

In an embodiment, the adjusting, using the planning module of the second component, the trajectory based on the objects identified by the perception module of the second component may comprise: adjusting the trajectory, using the planning module of the second component, the trajectory based on the occupancy grid.

In an embodiment, the computer-implemented method may further comprise: computing, for each occupancy grid, a set of control constraints, the set of control constraints defining permitted actions of the AV, wherein each control constraint of the set of control constraints may defined by an intersection of two control planes, wherein the two control planes may be optionally selected from a list including acceleration, deceleration, steering angle, steering rate, jerk, and velocity, wherein optionally the computing the set control constraints for each occupancy grid comprises computing the set control constraints using a graphical processing unit.

The term “control plane” may be understood as a dynamic parameter. The use of control constraints makes computation by the planning module more efficient than using the grid or other forms of object identification

In an embodiment, the computer-implemented method may further comprise: comparing the first and second occupancy grids; either: combining the first and second occupancy grids when the respective states match; or when a corresponding state between first and second occupancy grids do not match, checking each of the corresponding states with a corresponding state of the third occupancy grid, and selecting the state of the first and second occupancy grids that matches the corresponding state of the third occupancy grid.

In this way, reliability of the stack is improved because any false positives or false negatives in the occupancy grids will be ignored.

In an embodiment, the one or more rules-based models may include a RADAR based model for identifying objects from RADAR sensor inputs and a LiDAR based model for identifying objects from LiDAR sensor inputs, wherein the checking each of the corresponding states may comprise: when the state comprises occupancy, checking the state with the corresponding state of the occupancy grid generated by the RADAR based model and the state with the corresponding state of the occupancy grid generated by the LIDAR based model; when the state comprises an occlusion, checking the state with the corresponding state of the occupancy grid identified by the LiDAR model; and when the state comprises velocity, checking a radial velocity component of the velocity with the state of the occupancy grid generated by the RADAR based model.

The implementation of combining grids is difficult because certain sensor modalities do not identify all of the states, i.e. occupied, velocity, occluded, and free-space. Therefore, specific checks need to be made against grids derived only from specific sensor modalities.

In an embodiment, the computer-implemented method may further comprise: generating a confidence score associated with each state; and by-passing the comparison if the score is above a confidence threshold.

Bypassing reduces the risk of a true-positive being ignored in situations where only one sensor modality can detect an object. For example, a black object at night can only be reliably detected using radar, not images or LiDAR. Assigning a high confidence score to such identifications means that such instances are not ignored.

In an embodiment, the generating, using the planning module of the first component, a trajectory for the AV based on the objects identified by the perception module of the first component, may comprise generating a nominal trajectory for the AV and generating a minimal risk manoeuvre, MRM, trajectory for the AV, and wherein the adjusting, using the planning module of the second component, the trajectory based on the objects identified by the perception module of the second component may comprise adjusting the nominal trajectory and/or the MRM trajectory to avoid objects identified by the perception module of the second component.

In an embodiment, the computer-implemented method, may further comprise: generating a further MRM trajectory based solely on the objects identified by the perception module of the second component, the MRM configured to avoid any collisions with the objects identified by the perception module of the second component; determining if the adjusted nominal trajectory, the adjusted MRM trajectory, and the further MRM trajectory are collision free by comparison with the objects identified by the perception module of the second component; selecting the adjusted nominal trajectory as a final trajectory if the adjusted nominal trajectory is collision free; if the adjusted nominal trajectory is not collision free, selecting the adjusted MRM trajectory as the final trajectory if the adjusted MRM trajectory is collision free; and if the further MRM trajectory is collision free, selecting the further MRM trajectory as the final trajectory.

The further MRM trajectory may include something that is the safest for the current operating domain. For example, the operating domain of off road, the further MRM can be an emergency stop in lane.

In an embodiment, the generating, using the planning module of the first component, a trajectory for the AV may be further based on the objects identified by the perception module of the second component.

In this way, the trajectory generated by the first component will be more conservative, especially if the objects that it identifies are generic

In an embodiment, the perception module of the second component may further comprise a localisation validator, and/or wherein the planning module of the second component may comprise a control module configured to operate one or more actuators of the AV to move the AV according to the adjusted trajectory.

According to an aspect of the subject matter of the present disclosure, there is provided a computer-implemented method of training a machine learning algorithm of a perception module of a second component in an autonomy stack for controlling an autonomous vehicle, AV, to identify objects from sensor inputs. The autonomy stack including a first component and the second component, the first component for generating a trajectory for the AV based on sensor inputs and the second component for adjusting the trajectory based on the sensor inputs, the first component including a perception module and a planning module, and the second component including the perception module and a planning module. The perception module of the second component includes one or more rules-based models and one or more machine learning models. The computer-implemented method comprises: identifying, using the one or more rules-based models, objects using sensor inputs; labelling the sensor inputs and the identified objects automatically as paired data; and training the one or more machine learning models to identify objects using the paired sensor inputs and identified objects.

Automatically labelling the training data reduces the burden of manual labelling.

In an embodiment, the identifying, using the one or more rules-based models objects, may comprise generating, by each rules-based model, an occupancy grid including a plurality of grid segments each labelled with a state selected from a list including occupied, occluded, and free-space, wherein the labelling may comprise labelling the sensor inputs and occupancy grids automatically as paired data, and wherein the training the one or more machine learning models may include training the one or more machine learning models to generate respective occupancy grids using the paired sensor inputs and occupancy grids.

In an embodiment, the computer-implemented method may further comprise: labelling the sensor inputs and occupancy grid of a future and/or past time point as temporal paired data, wherein the training the one or more machine learning models may comprise training the one or more machine learning models to generate the occupancy grid with the occupancy state including velocity of an occupying object using the temporal paired data.

In this way, training data can be automatically labelled to train the machine learning model to predict object velocity.

According to an aspect of the subject-matter of the present disclosure, there is provided a transitory, or non-transitory, computer-readable medium including instructions stored thereon that when executed by a processor, cause the processor to perform the computer-implemented method of any preceding aspect or embodiment.

According to an aspect of the subject-matter of the present disclosure, there is provided an autonomy stack for an autonomous vehicle, AV. The autonomy stack comprises a first component and a second component, the first component for generating a trajectory for the AV based on sensor inputs and the second component for adjusting the trajectory based on the sensor inputs, the first and second components each including a perception module and a planning module, wherein: the perception module of the first component is configured to identify objects based on sensor inputs; the planning module of the first component is configured to generate a trajectory for the AV based on the objects identified by the perception module of the first component; the perception module of the second component is configured to identify objects based on the sensor inputs; and the planning module of the second component is configured to adjust the trajectory based on the objects identified by the perception module of the second component, wherein the perception module of the second component includes one or more rules-based models and one or more machine learning models.

According to an aspect of the present disclosure, there is provided an autonomous vehicle, AV, including a processor and storage, wherein the storage has stored thereon the non-transitory computer readable medium defined by the preceding aspect or the autonomy stack defined by the preceding aspect.

### BRIEF DESCRIPTION OF DRAWINGS

The subject-matter of the present disclosure is best described with reference to the accompanying figures, in which:

FIG. 1 shows a schematic block diagram of an autonomous vehicle (AV) according to one or more embodiment;

FIG. 2 shows a block diagram of an architecture of an autonomy stack for controlling the AV from FIG. 1, according to one or more embodiments;

FIG. 3 shows block diagram a part of the architecture of the autonomy stack from FIG. 2, according to one or more embodiments;

FIG. 4 shows a flow chart of a computer-implemented method of generating a trajectory for the AV, using the autonomy stack from FIGS. 2 and 3; and

FIG. 5 shows a flow chart of training a machine learning model included in the autonomy stack of FIGS. 2 and 3, according to one or more embodiments.

### DESCRIPTION OF EMBODIMENTS

At least some of the example embodiments described herein may be constructed, partially or wholly, using dedicated special-purpose hardware. Terms such as ‘component’, ‘module’ or ‘unit’ used herein may include, but are not limited to, a hardware device, such as circuitry in the form of discrete or integrated components, a Field Programmable Gate Array (FPGA) or Application Specific Integrated Circuit (ASIC), which performs certain tasks or provides the associated functionality. In some embodiments, the described elements may be configured to reside on a tangible, persistent, addressable storage medium and may be configured to execute on one or more processors. These functional elements may in some embodiments include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. Although the example embodiments have been described with reference to the components, modules and units discussed herein, such functional elements may be combined into fewer elements or separated into additional elements. Various combinations of optional features have been described herein, and it will be appreciated that described features may be combined in any suitable combination. In particular, the features of any one example embodiment may be combined with features of any other embodiment, as appropriate, except where such combinations are mutually exclusive. Throughout this specification, the term “comprising” or “comprises” means including the component(s) specified but not to the exclusion of the presence of others.

The embodiments described herein may be embodied as sets of instructions stored as electronic data in one or more storage media. Specifically, the instructions may be provided on a transitory or non-transitory computer-readable media. When executed by the processor, the processor is configured to perform the various methods described in the following embodiments. In this way, the methods may be computer-implemented methods. In particular, the processor and a storage including the instructions may be incorporated into a vehicle. The vehicle may be an autonomous vehicle (AV).

Whilst the following embodiments provide specific illustrative examples, those illustrative examples should not be taken as limiting, and the scope of protection is defined by the claims. Features from specific embodiments may be used in combination with features from other embodiments without extending the subject-matter beyond the content of the present disclosure.

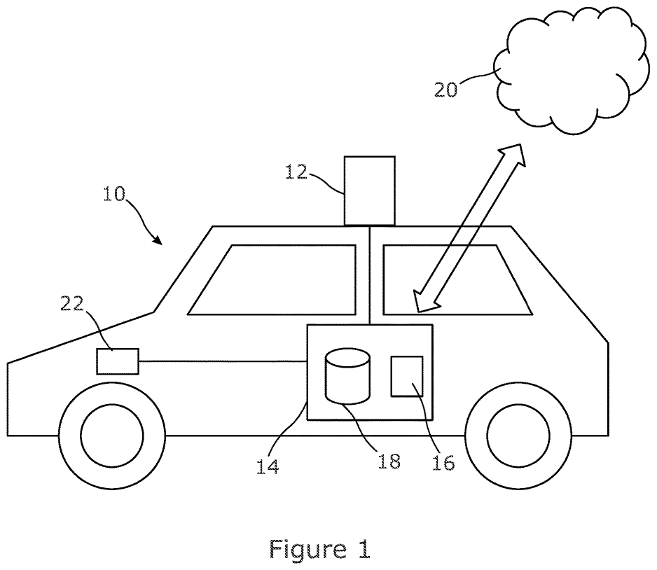

With reference to FIG. 1, an AV 10 may include a plurality of sensors 12. The sensors 12 may be mounted on a roof of the AV 10, or integrated into the bumpers, grill, bodywork, etc. The sensors 12 may be communicatively connected to a computer 14. The computer 14 may be onboard the AV 10. The computer 14 may include a processor 16 and a memory 18. The memory may include the non-transitory computer-readable media described above. Alternatively, the non-transitory computer-readable media may be located remotely and may be communicatively linked to the computer 14 via the cloud 20. The computer 14 may be communicatively linked to one or more actuators 22 for control thereof to move the AV 10. The actuators may include, for example, a motor, a braking system, a power steering system, etc.

The sensors 12 may include various sensor types. Examples of sensor types include LiDAR sensors, RADAR sensors, and cameras. Each sensor type may be referred to as a sensor modality. Each sensor type may record data associated with the sensor modality. For example, the LiDAR sensor may record LiDAR modality data.

The data may capture various scenes that the AV 10 encounters. For example, a scene may be a visible scene around the AV 10 and may include roads, buildings, weather, objects (e.g. other vehicles, pedestrians, animals, etc.), etc.

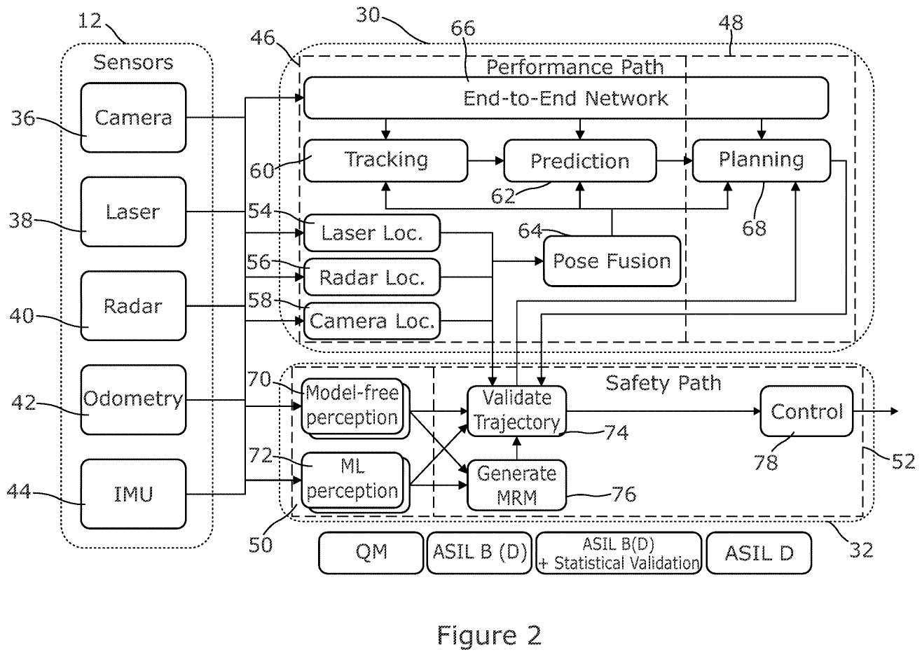

With reference to FIG. 2, the instructions may form an autonomy stack. The autonomy stack includes a first component 30 and a second component 32. The first component 30 is for generating a trajectory for the AV based on sensor inputs 34 and the second component 32 is for adjusting the trajectory based on the sensor inputs 34. The sensor inputs for the first and second components 30, 32, may inputs from the same sensors 12.

As alluded to above, the sensor inputs may be inputs from sensors 12 of different modalities. For example, the inputs may be from a camera 36, a LIDAR sensor 38, a RADAR sensor 40, odometry 42, and inertial measurement units (IMUs) 44.

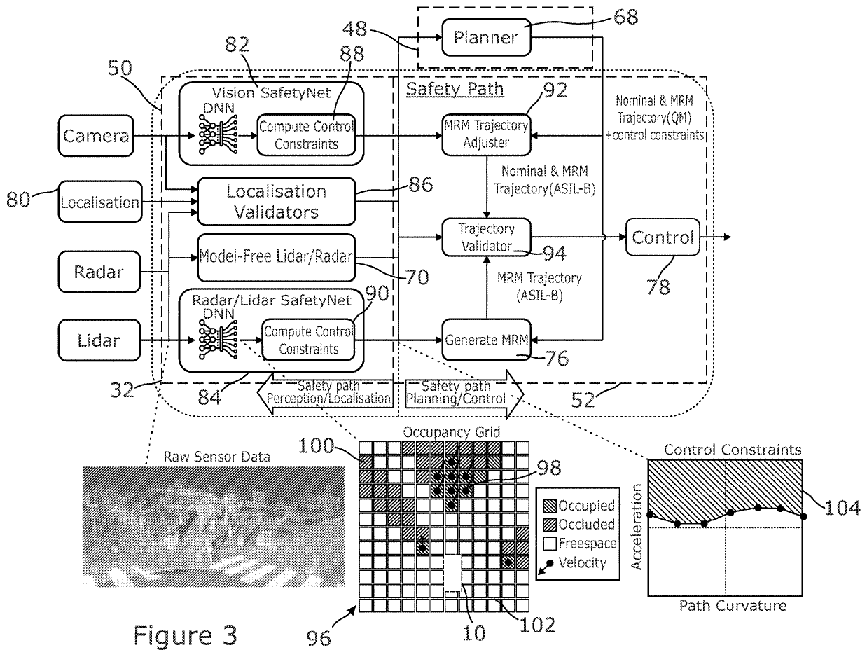

The first component 30 includes a perception module 46 and a planning module 48. The second component 32 also includes a perception module 50 and a planning module 52. Each of these modules includes further modules as described below. However, in summary, the perception module 46 of the first component 30 comprises a laser (LiDAR) localiser 54, a radar localiser 56, a camera localiser 58, a tracking module 60, a prediction module 62, a pose fusion module 64, and a first part of an end-to-end machine learning model 66, which may be a network such as a neural network. The planning module 48 of the first component 30 includes a planner 68 and a second portion of the end-to-end network 66. FIG. 2 provides a condensed version of the second component 32, and a more detailed view is provided in FIG. 3. For the purposes of FIG. 2, the perception module 50 of the second component 32 includes a model-free perception module 70 and a machine learning (ML) perception module 72. For the purposes of FIG. 3, the planning module 52 includes a validate trajectory module 74, a generate minimal risk manoeuvre, MRM, module 76, and a control module 78.

The respective localisers 54, 56, 58, identify objects in a scene and their respective positions relative to the AV 10. The positions of the objects relative to the AV 10 are fused using the pose fusion module 64. The fused positions are output to the tracking module 60, the prediction module 62, and the planning module 68.

The end-to-end network 66 is configured to output a trajectory for the AV 10 based on sensor inputs from the various sensors 12.

At a hidden layer of the network 66, positions of objects are identified relative to the AV 10. The positions are output to the tracking module 60 and decoded by a decoder to a form similar to the form output by the pose fusion module 64. The tracking module 60 is configured to fuse the positions and track them temporally to predict the respective velocity of each object.

The prediction module 62 is configured to receive the object positions from the pose fusion module 64, the object positions and velocities from the tracking module 60, and the object positions and velocities from a hidden layer of the end-to-end network 66. The prediction module 62 is configured to predict positions of the objects relative to the AV 10 at future time points.

The planner module 68 is configured to receive the predicted future positions of the objects from the prediction module 62, the positions of the objects from the pose fusion module 64 and a trajectory from the end-to-end network 66. The trajectory from the end-to-end network 66 may be the output from the network 66. Based on these inputs, the planner module 68 is configured to generate a trajectory for the AV 10. The trajectory may include a nominal trajectory and an MRM trajectory. The trajectory is output to the validate trajectory module 74.

The end-to-end network 66 is a machine learning model. The other modules 54-64, 68, of the first component 30 are rules-based models. In some embodiments, the other modules 54-56, 68, of the first component may be machine learning models each trained separately.

The modules and functionality of the second component 32 are best described with reference to FIG. 3.

With reference to FIG. 3, the sensors 12 may also include a localisation 80 of the AV 10 from a map. The ML perception module 72 may include a first machine learning model 82 and a second machine learning model 84. The perception module 50 of the second component 32 may further comprise a localisation validation model 86, a first compute control constraint module 88, and a second compute control constraint module 90. The validate trajectory module 74 may include a trajectory adjuster module 92, and a trajectory validator module 94. The localisation validation module 86 is configured to validate the localisation of the AV 10.

The autonomy stack, and more particularly, the second component of the autonomy stack, may be operated as a computer-implemented method. The method may include various steps as outlined below.

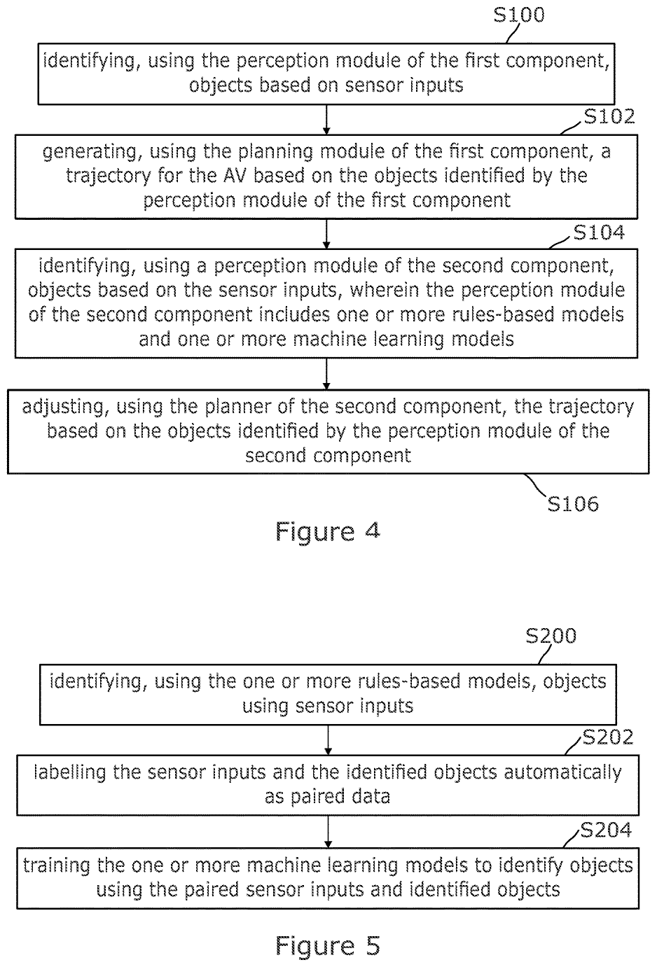

In summary, and as shown in FIG. 4, the method may be summarised as a computer-implemented method of generating a trajectory for an autonomous vehicle, AV, 10 using an autonomy stack, the autonomy stack including a first component 30 and a second component 32, the first component 30 for generating a trajectory for the AV based on sensor inputs and the second component 32 for adjusting the trajectory based on the sensor inputs, the first and second components 30, 32 each including a perception module 46, 50 and a planning module 48, 52, the computer-implemented method comprising: identifying S100, using the perception module 50 of the first component, objects based on sensor inputs; generating S102, using the planning module 48 of the first component, a trajectory for the AV based on the objects identified by the perception module 46 of the first component; identifying S104, using a perception module 50 of the second component, objects based on the sensor inputs; and adjusting S106, using the planning module 52 of the second component, the trajectory based on the objects identified by the perception module 50 of the second component, wherein the perception module 50 of the second component includes one or more rules-based models and one or more machine learning models.

With further reference to FIG. 3, the identification of the objects by the perception module of the second component includes identifying the objects and labelling the objects as generic objects. The term “generic” is used to mean no semantic labels are added. In other words, all objects may be treated equally. This may be in contrast to the object identification occurring in the first component, where the objects may be labelled according to their semantic class, e.g. a vehicle, a pedestrian, a dog, a mailbox, etc. In this way, the computation takes less time to compute the objects and use them for further processing operations. In addition, by not classifying the objects semantically, the second component becomes more conservative.

To identify the objects, the first machine learning model 82 is trained to identify objects from images. The first machine learning model 82 may be a neural network, and preferably a deep neural network. The neural network may comprise, or may be, a convolutional neural network.

To identify the object, the second machine learning model 84 is trained to identify objects from RADAR and/or LiDAR data. The RADAR and LiDAR data may be provided in the forms of point clouds. To achieve this, the second machine learning model 84 may comprise two independent machine learning models one for each modality. Alternatively, the RADAR and LiDAR data may be combined into a single point cloud and the second machine learning model 84 identifies the objects using the single point cloud as inputs.

The second machine learning model 84 may be a neural network, and preferably may be a deep neural network. The neural network may comprise, or may be, a recurrent neural network, or may be, or may comprise, a convolutional neural network.

The identification of the objects by the first and second machine learning models, 82, 84, may include generating first and second occupancy grids 96, respectively. The respective occupancy grids each include a plurality of grid segments. Each segment may be labelled with a state. Overall, the states define whether or not the AV 10 is able to travel in that segment based on the presence of any objects in an area covered by the grid. The states may include occupied 98, where the segment is occupied by an object. The occupied state may be accompanied by a velocity of the object that occupies that state if the respective machine learning model 82, 84, has been trained to detect object velocities in addition to position. The states may also include occluded 100, where the segment is unreachable because of an occupied 98 state of a grid segment between it and the AV 10. The states may also include free-space 102. A free-space 102 state grid is one available for the AV 10 to travel to.

The method may also comprise computing, using the compute constraint modules 88, 90, a set of control constraints 104 for each occupancy grid. The set of control constraints defines permitted action spaces for the AV 10. The control constraints may be defined by an intersection of two control planes. A control plane is used herein to mean a dynamic parameter. The two control planes may include one of acceleration, deceleration, steering angle, steering rate, jerk, and velocity. For example, the control constraint may be the variability of one control plane with respect to, or in the domain of, another control plane. For example, the control constraint may be the variability of acceleration in the steering angle domain, or in other words, how much the AV can accelerate at any given steering angle and avoid a collision with the identified objects. The control constraint 104 is shown graphically in FIG. 3. Computing the control constraint for each occupancy grid may comprise computing the control constraint using a graphical processing unit (GPU). Using a GPU at the end of the respective machine learning model reduces bandwidth and central processing unit (CPU) usage with downstream functions of the second component 32.

Calculating the control constraint may be performed based on each of the first and second occupancy grids. In other embodiments, the control constraints 104 may be computed for a combined occupancy grid. Combining the occupancy grids may reduce the impact of false grid predictions, e.g. where a segment is occupied in one grid and free-space in another grid. The method of combining the occupancy grids may be defined as follows.

The method may comprise comparing the first and second occupancy grids. When the states of both occupancy grids match one another, the grids may be combined. When any states of the occupancy grids do not match, the mismatched grid segments may be compared to the same segment of an occupancy grid generated by the rules-based model, e.g. the model-free perception module 70. In some embodiments this may be at a segment-by-segment level, in other embodiments, entire grids will be compared.

It should be noted that this final check with the grid from the rules-based model-free perception module 70 is non-trivial. This is because the grids output by the model-free perception module 70 may not include all states depending on the modality of the sensor inputs.

For example, occupancy states can be checked using grids generated based on either RADAR or LiDAR modality sensor inputs. With the above in mind, it should be noted that the model-free perception module 70, or rules-based perception module, can include a RADAR based model and a LiDAR based model. The RADAR based model identifies objects from RADAR sensor inputs. The LiDAR based model identifies objects from LiDAR sensor inputs.

Occlusion states are difficult to check against RADAR derived grids, and instead should be checked using LiDAR derived grids. Velocity is difficult to check against LiDAR derived grids. A radial component of velocity can be checked using a RADAR derived grids. For velocity in general, a temporal consistency check may be performed using future and/or past grids generated from either the rules based module or the machine learning models.

In some embodiments, the method comprises generating a confidence score associated with each state and by-passing the comparison of the first and second occupancy grids if the score is above a confidence threshold. This may be particularly beneficial for certain circumstances such as not removing true positive states for rare objects or objects only detectable through one modality. For instance, a black object at night will unlikely be detectable from images and LiDAR but may be detectable by radar.

It will be appreciated that the planner module of the first component 30 generates the trajectory based on inputs from various first component modules and also based on the outputs of the perception module of the second component 32. In this way, since the outputs of the perception module are more conservative, due at least in part to them relating to generic objects, the trajectory will be more conservative.

The trajectory generated by the planning module 68 of the first component 30 includes a nominal trajectory for the AV and an MRM trajectory for the AV. The MRM trajectory may involve actions such as changing lane or pulling to the side of a road, for example. The method may include adjusting, using the MRM adjuster module 92, the trajectory based on the objects identified by the perception module of the second component. More specifically, the trajectory may be adjusted based on the occupancy grid(s). This may be directly from the occupancy grids per se, or indirectly by basing the adjustment on the control constraints. This may be achieved by adjusting the nominal trajectory and the MRM trajectory to avoid collisions with objects detected by the perception module of the second component 32, while not compromising on passenger comfort.

The method may also include, generating, using a generate MRM module 76, a further MRM trajectory based solely on the objects identified by the perception module of the second component 32. The further MRM trajectory may be configured to avoid any collisions with the objects identified by the perception module 50 of the second component 32. The further MRM trajectory will be more conservative compared to the MRM trajectory because it is determined solely based on generic objects.

Next, the method includes selecting a final trajectory from the adjusted nominal trajectory, the adjusted MRM trajectory, and the further MRM trajectory. This is done using the trajectory validator module 94. The trajectory validator module 94 may also select the final trajectory based on comfort of occupants in the AV 10, e.g. jerk being below a threshold. The selection of a final trajectory may have a fixed priority order from the three trajectories (adjusted nominal, adjusted MRM, and further MRM). The fixed priority order is determined by the trajectory validator module 94. The order may be decided based on a risk of collisions between the AV 10 and an object, for example. The order may be based on determining if the adjusted nominal trajectory, the adjusted MRM trajectory, and the further MRM trajectory are collision free by comparison with the objects identified by the perception module of the second component; selecting the adjusted nominal trajectory as a final trajectory if the adjusted nominal trajectory is collision free; if the adjusted nominal trajectory is not collision free, selecting the adjusted MRM trajectory as the final trajectory if the adjusted MRM trajectory is collision free; and if the further MRM trajectory is collision free, selecting the further MRM trajectory as the final trajectory

The control module 78 may be configured to convert the final trajectory to a set of actuator configurations so the AV 10 can execute the final trajectory.

Since the first and second machine learning models 82, 84, are data based, they require training. The computer-implemented method for training the machine learning models can be summarised with reference to FIG. 5.

With reference to FIG. 5, a summary of the computer-implemented method of training a machine learning algorithm of a perception module of a second component in an autonomy stack for controlling an autonomous vehicle, AV, comprises: identifying S200, using the one or more rules-based models, objects using sensor inputs; labelling S202 the sensor inputs and the identified objects automatically as paired data; and training S204 the one or more machine learning models to identify objects using the paired sensor inputs and identified objects.

The objects identified by the rules-based models can include generating an occupancy grid as described above. Training data can be generated by pairing the occupancy grids with the sensor inputs used to generate them. The machine learning model can be trained to generate their own occupancy grids based on sensor inputs.

Such training data works well for states such as occupancy, occlusion, and free-space. However, velocity is more difficult. To train the machine learning models to determine velocity of an object, the sensor inputs may be paired with occupancy grids of future time points generated by the rules-based perception model. In this way, the training data will be temporal paired data. In this way, the machine learning models will be trained to generate an occupancy grid with the occupancy state including velocity of an occupying object using the temporal paired data.

While the invention has been illustrated and described in detail in the drawings and foregoing description, such illustration and description are to be considered illustrative or exemplary and not restrictive; the invention is not limited to the disclosed embodiments.

Other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. A single processor or other unit may fulfil the functions of several items recited in the claims. The mere fact that certain measures are recited in mutually different dependent claims does not indicate that a combination of these measured cannot be used to advantage. Any reference signs in the claims should not be construed as limiting the scope.

1. A computer-implemented method of generating a trajectory for an autonomous vehicle, AV, using an autonomy stack, the autonomy stack including a first component and a second component, the first component for generating a trajectory for the AV based on sensor inputs and the second component for adjusting the trajectory based on the sensor inputs, the first and second components each including a perception module and a planning module, the computer-implemented method comprising:
identifying, using the perception module of the first component, objects based on sensor inputs;
generating, using the planning module of the first component, a trajectory for the AV based on the objects identified by the perception module of the first component;
identifying, using a perception module of the second component, objects based on the sensor inputs; and
adjusting, using the planning module of the second component, the trajectory based on the objects identified by the perception module of the second component,
wherein the perception module of the second component includes one or more rules-based models and one or more machine learning models.

2. The computer-implemented method of claim 1, wherein, the identifying, using the perception module of the first component, objects based on sensor inputs comprises identifying, by the perception module of the first component, the objects and labelling, by the perception module of the first component, the objects semantically, and wherein, the identifying, using the perception module of the second component, objects based on the sensor inputs comprises identifying, using the perception module of the second component, the objects and labelling, by the perception module of the second component, each of the identified objects as generic objects.

3. The computer-implemented method of claim 1, wherein the one or more machine learning models trained to identify objects from sensor inputs comprises a first machine learning model trained to identify objects based on input images.

4. The computer-implemented method of claim 3, wherein the one or more machine learning models trained to identify objects from sensor inputs comprises a second machine learning model trained to identify objects based on radar point cloud data and/or LiDAR point cloud data.

5. The computer-implemented method of claim 4, wherein the identifying, using the perception module of the second component, objects based on the sensor inputs comprises:
generating, using the first machine learning model, a first occupancy grid; and
generating, using the second machine learning model, a second occupancy grid,
wherein, the identifying, using the one of more rules-based models, a third occupancy grid,
wherein the first, second, and third occupancy grids each comprise a plurality of grid segments, each segment of the plurality of grid segments labelled with a state selected from a list of states including occupied and object velocity, free-space, and occluded.

6. The computer-implemented method of claim 5, wherein the adjusting, using the planning module of the second component, the trajectory based on the objects identified by the perception module of the second component comprises:
adjusting the trajectory, using the planning module of the second component, the trajectory based on the occupancy grid.

7. The computer-implemented method of claim 5, further comprising:
computing, for each occupancy grid, a set of control constraints, the set of control constraints defining permitted actions of the AV, wherein each control constraint of the set of control constraints is defined by an intersection of two control planes, wherein the two control planes are optionally selected from a list including acceleration, deceleration, steering angle, steering rate, jerk, and velocity, wherein optionally the computing the set control constraints for each occupancy grid comprises computing the set control constraints using a graphical processing unit.

8. The computer-implemented method of claim 6, further comprising:
comparing the first and second occupancy grids;
either:
combining the first and second occupancy grids when the respective states match; or
when a corresponding state between first and second occupancy grids do not match, checking each of the corresponding states with a corresponding state of the third occupancy grid, and selecting the state of the first and second occupancy grids that matches the corresponding state of the third occupancy grid.

9. The computer-implemented method of claim 8, wherein the one or more rules based models includes a RADAR based model for identifying objects from RADAR sensor inputs and a LIDAR based model for identifying objects from LiDAR sensor inputs, wherein the checking each of the corresponding states comprises:
when the state comprises occupancy, checking the state with the corresponding state of the occupancy grid generated by the RADAR based model and the state with the corresponding state of the occupancy grid generated by the LIDAR based model;
when the state comprises an occlusion, checking the state with the corresponding state of the occupancy grid identified by the LiDAR model; and
when the state comprises velocity, checking a radial velocity component of the velocity with the state of the occupancy grid generated by the RADAR based model.

10. The computer-implemented method of claim 8, further comprising:
generating a confidence score associated with each state; and
by-passing the comparison if the score is above a confidence threshold.

11. The computer-implemented method of claim 1, wherein the generating, using the planning module of the first component, a trajectory for the AV based on the objects identified by the perception module of the first component, comprises generating a nominal trajectory for the AV and generating a minimal risk manoeuvre, MRM, trajectory for the AV, and wherein the adjusting, using the planning module of the second component, the trajectory based on the objects identified by the perception module of the second component comprises adjusting the nominal trajectory and/or the MRM trajectory to avoid objects identified by the perception module of the second component.

12. The computer-implemented method of claim 11, further comprising:
generating a further MRM trajectory based solely on the objects identified by the perception module of the second component, the MRM configured to avoid any collisions with the objects identified by the perception module of the second component;
determining if the adjusted nominal trajectory, the adjusted MRM trajectory, and the further MRM trajectory are collision free by comparison with the objects identified by the perception module of the second component;
selecting the adjusted nominal trajectory as a final trajectory if the adjusted nominal trajectory is collision free;
if the adjusted nominal trajectory is not collision free, selecting the adjusted MRM trajectory as the final trajectory if the adjusted MRM trajectory is collision free; and
if the further MRM trajectory is collision free, selecting the further MRM trajectory as the final trajectory.

13. The computer-implemented method of claim 1, wherein the generating, using the planning module of the first component, a trajectory for the AV is further based on the objects identified by the perception module of the second component.

14. The computer-implemented method of claim 1, wherein the perception module of the second component further comprises a localization validator, and/or wherein the planning module of the second component comprises a control module configured to operate one or more actuators of the AV to move the AV according to the adjusted trajectory.

15. A computer-implemented method of training a machine learning algorithm of a perception module of a second component in an autonomy stack for controlling an autonomous vehicle, AV, to identify objects from sensor inputs, the autonomy stack including a first component and the second component, the first component for generating a trajectory for the AV based on sensor inputs and the second component for adjusting the trajectory based on the sensor inputs, the first component including a perception module and a planning module, and the second component including the perception module and a planning module, wherein the perception module of the second component includes one or more rules-based models and one or more machine learning models the computer-implemented method comprising:
identifying, using the one or more rules-based models, objects using sensor inputs;
labelling the sensor inputs and the identified objects automatically as paired data; and
training the one or more machine learning models to identify objects using the paired sensor inputs and identified objects.

16. The computer-implemented method of claim 15, wherein the identifying, using the one or more rules-based models objects, comprises generating, by each rules-based model, an occupancy grid including a plurality of grid segments each labelled with a state selected from a list including occupied, occluded, and free-space, wherein the labelling comprises labelling the sensor inputs and occupancy grids automatically as paired data, and wherein the training the one or more machine learning models includes training the one or more machine learning models to generate respective occupancy grids using the paired sensor inputs and occupancy grids.

17. The computer-implemented method of claim 16, further comprising:
labelling the sensor inputs and occupancy grid of a future and/or past time point as temporal paired data,
wherein the training the one or more machine learning models comprises training the one or more machine learning models to generate the occupancy grid with the occupancy state including velocity of an occupying object using the temporal paired data.

18-20. (canceled)
